(19) United States
(12) Patent Application Publication
(10) Pub. No.: US 2023/0235146 A1
(43) Pub. Date: Jul. 27, 2023

(54) Gels, Porous Bodies, and Method of Preparing a Gel or a Porous Body

(71) Applicant: Japan Atomic Energy Agency, Naka-gun, Ibaraki (JP)

(72) Inventors: Yurina SEKINE, Nakagun, Ibaraki (JP); Takuya NANKAWA, Nakagun, Ibaraki (JP)

(21) Appl. No.: 18/010,855

(22) PCT Filed: Mar. 19, 2021
(86) PCT No.: PCT/JP2021/011482

§ 371 Date: Dec. 16, 2022

(30) Foreign Application Priority Data
Jun. 18, 2020 (JP) 2020-105534

(51) Int. Cl. C08J 9/28; C08J 3/075; C08J 3/24

(52) U.S. Cl. CPC C08J 9/28; C08J 3/075; C08J 3/246; C08J 2301/28

(57) ABSTRACT

[PROBLEMS] To easily provide gels and porous bodies having high strength.

[SOLVING MEANS] A method of producing a porous body according to the present invention is characterized by having a first step of dissolving fibrous polymers each having a reactive functional group in a solution, a second step of freezing the solution in which the fibrous polymers are dissolved, and a third step of cross-linking fibrous polymers to each other by adding a predetermined amount of cross-linking agent to the frozen solution.

### TECHNICAL FIELD OF THE INVENTION

The present invention relates to gels, porous bodies, and a method of preparing a gel or a porous body, and more particularly to a polymer porous body obtained by cross-linking a fibrous polymer in a frozen state with a predetermined chemical.

### PRIOR ART

Conventionally, many porous bodies obtained by three-dimensionally cross-linking a polymer have water retention and biocompatibility, and are used in a wide range of fields from adsorbent materials to medical materials. On the other hand, in order to use it in the environment and medical fields, it is required to be a harmless and environment-friendly material.

The polymers constituting the porous body are roughly classified into synthetic polymers and natural polymers. When a synthetic polymer is used, the gel is generally synthesized mainly by radical polymerization with a cross-linking agent as seen in acrylamide gels. Since a polymerization initiator is used when performing radical polymerization, the toxicity of the polymerization initiator remaining in the prepared porous body may become a problem. Therefore, it cannot be used in some usages in the medical field.

On the other hand, natural polymers are not toxic and have excellent biosynthesis, so they are widely used as wound sealants and drug carriers during surgery. However, the natural polymers capable of synthesizing gels are limited. In addition, since heating at a high temperature is required during synthesis, its use may be restricted depending on the application, for example, inclusion of materials susceptible to heat such as proteins and cells.

From the above background, there is a demand for a porous polymer having higher versatility, lower environmental load, simpler synthesis method, and lower cost.

Cellulose is attracting attention as a natural polymer that meets the above requirements. For example, as a method of synthesizing a porous body using cellulose, there is a method using carboxymethyl cellulose in which a carboxyl group is introduced into cellulose, and various studies have been conducted on a synthesis method of changing the physical properties thereof.

The method of synthesizing a porous body using cellulose described in Patent Document 1 is a method of synthesizing a gel by adding an acid to carboxymethyl cellulose to cause cross-linking between carboxymethyl cellulose molecules.

### PRIOR ART LITERATURE

### Patent Document

[Patent Document 1] JP 2008-69315 A

### BRIEF SUMMARY OF INVENTION

### Problems to be Solved by the Invention

In the method of synthesizing a cellulose porous body described in Patent Document 1, a gel can be synthesized simply by kneading an acid and carboxymethyl cellulose. It is, therefore, possible to provide a safe cellulose porous body without the need to use toxic reagents.

However, as a result of measuring the strength of the gel synthesized by the method described in Patent Document 1, the inventors have found that the strength is not sufficient. Similarly, the strength of the porous material remaining when the water was removed from the gel also was not sufficient.

When the above gel or porous material is used in a place where a certain amount of force is applied, the cellulose gel itself may be destroyed before exerting its function. It is, therefore, necessary to further improve the strength.

Further, in the method described in Patent Document 1, it is necessary to use a high concentration of carboxymethyl cellulose of about 20 wt % at the time of synthesis, but it is extremely difficult to prepare it, because a high concentration polysaccharide aqueous solution has generally a high viscosity.

The present invention has been made in view of the above problems, and an object of the present invention is to easily provide gels and porous bodies having high strength.

### Means for Solving the Problems

In order to solve the above problems, the method of preparing a porous body according to the present invention is characterized by having a first step of dissolving fibrous polymers each having a reactive functional group in a solution, a second step of freezing the solution in which the fibrous polymers are dissolved, and a third step of cross-linking fibrous polymers to each other by adding a predetermined amount of cross-linking agent to the frozen solution.

Further, the porous body according to the present invention is characterized in that it is obtained by cross-linking in a frozen state the solution in which fibrous polymers each having a reactive functional group are dissolved, thawing the frozen solution after cross-linking, then drying.

Further, the gel containing fibrous polymers as a main component is characterized in that when compressed at an 80% compressibility, it has substantially the same stress-strain curve for at least twice compressions.

### Effect of the Invention

By the present invention, gels and porous bodies having high strength are provided easily.

Further, new problems and effects which are not described in the above-mentioned problems and effects will be clarified in the description of the mode for carrying out the invention.

### BRIEF DESCRIPTION OF DRAWINGS

FIG. 1(a) is a diagram illustrating a conventional method of synthesizing a gel, and FIG. 1(b) is a diagram illustrating a method of synthesizing a gel according to the present invention.

FIG. 2(a) is a schematic diagram illustrating the concept of gel synthesis in the prior art, and FIG. 2(b) is a schematic diagram illustrating the concept of gel synthesis according to the present invention.

FIG. 3 is a diagram showing a gel synthesized by the method of experimental example 1 of the present invention.

FIG. 4 is a diagram illustrating the stress-strain curve of the gel obtained by the method of experimental example 1 of the present invention.

FIG. 5 is a diagram showing the gel synthesized by the method of comparative example 1 of the present invention.

FIG. 6 is a diagram showing the stress-strain curve of the gel obtained by the method of comparative example 1 of the present invention.

FIG. 7 shows an aqueous solution to which the dye of experimental example 5 of the present invention was added, in which (a) shows a basic blue aqueous solution, (b) shows a methylene blue aqueous solution, (c) shows a malachite green aqueous solution, and (d) shows a rhodamine B aqueous solution.

FIG. 8 shows the porous body obtained in experimental example 3 of the present invention, in which (a) shows the porous body added to an aqueous solution of basic blue and stirred, then 12-hour elapsed, (b) shows one added to the aqueous solution of methylene blue, (c) shows one added to the aqueous solution of malachite green, and (d) shows one added to the aqueous solution of Rhodamine B. Where, (b) through (d) were treated same as (a), respectively.

FIG. 9 shows the surface state of the gel of the present invention, in which (a) shows a gel synthesized by the method of experimental example 1, (b) one synthesized by the method of comparative example 1, and (c) one synthesized by the method of experimental example 2.

FIG. 10 is a diagram illustrating the stress-strain curve of the gel obtained by the method of experimental example 2 of the present invention.

FIG. 11 shows a table summarizing the experimental results of experimental examples 1 to 4 and comparative examples 1 to 3 of the present invention.

FIG. 12 is a diagram showing a film-like porous body in experimental example 6 of the present invention.

### BEST MODE FOR CARRYING OUT THE INVENTION

Hereinafter, embodiments of the gel and the porous body according to the present disclosure will be described with reference to the drawings.

### First Embodiment

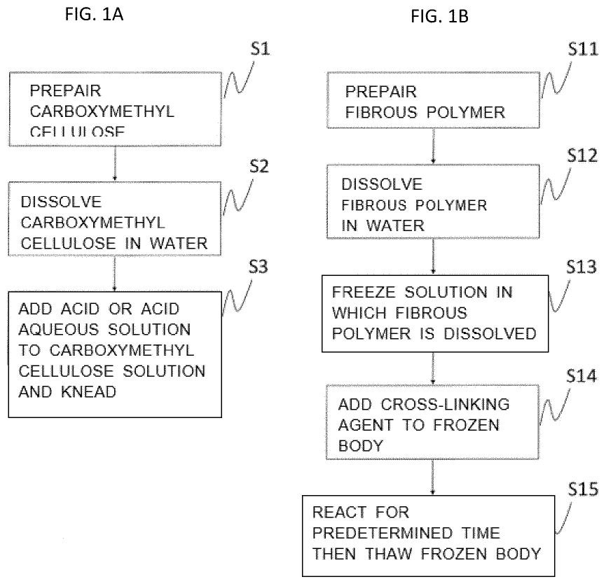

The most characteristic point of the present invention exists in a gel synthesis method. FIG. 1(a) is a flowchart illustrating a gel synthesis method according to the prior art, and FIG. 1(b) is a flowchart illustrating a gel synthesis method according to the present invention.

In the conventional gel synthesis method, carboxymethyl cellulose is first prepared in step S1, then the carboxymethyl cellulose is dissolved in water in step S2. Finally, in step S3, an acid or an acid aqueous solution is added to the carboxymethyl cellulose solution and kneaded to obtain a cellulose gel.

On the other hand, in the method of synthesizing a gel according to the present invention, a fibrous polymer is prepared in step S11 as shown in FIG. 1(b). Then, in step S12, the fibrous polymer is dissolved in water. The following steps S13 and S14 are the most important points in the present invention.

In the conventional technique, carboxymethyl cellulose is dissolved in water, then an acid or an acid aqueous solution is immediately added to form cross-linking. However, in the present invention, first, the solution in which the fibrous polymer is dissolved is frozen in step S13, then in step S14, a cross-linking agent is added to the frozen body to synthesize a gel. Finally, the process proceeds to step S15, where the cross-linking reaction is carried out for a predetermined time, then the frozen body is thawed to obtain a gel product. As will be described later, the gel body thus obtained is imparted with high strength unlike the gel body obtained by using the prior art.

Note that the high strength in the present invention means that it is not destroyed even if the so-called slight force is applied and has high compression restorability.

When the gel synthesis method according to the present invention is used, there is an advantage in terms of formability as compared with the conventional method. When using the prior art, in order to synthesize a gel having a complicated structure, it is necessary to put the solution in a container having the complicated structure. At this time, even if an acid is added to the container to knead the solution, it is difficult to spread the acid to the details of the container and uniformly crosslink the mixture because of the complicated container structure.

Therefore, even if a gel having a complicated structure is produced by using the conventional technique, the strength of the details is weak and its shape cannot be sufficiently maintained.

On the other hand, when the gel synthesis method according to the present invention is used, the gel is synthesized by applying a cross-linking agent to the frozen body, so that the cross-linking reaction proceeds from the outer peripheral portion of the frozen body. Therefore, since it is strongly crosslinked from the outer peripheral portion of the frozen body, it becomes possible to easily synthesize a gel having a complicated structure.

### Fiber-Like Polymer

The fibrous polymer having at least one of a carboxyl group a sulfone group, an anionic group, an amino group, an amide group and a hydroxyl group, as a hydrophilic group in the molecule can be used in the present invention. More specifically, as the fibrous polymer used in the present invention, cellulose, carboxymethyl cellulose, chitosan, chitin, agarose, alginic acid, polyethylene glycol, polypropylene glycol, polyvinyl alcohol, poly (meth) acrylamide, collagen and the like can be used.

When synthesizing a gel according to the present invention, at least one of the above-mentioned fibrous polymers will be selected depending on the application. As an example, when it is used in a part that comes into contact with the human body for medical purposes, it is preferable to select carboxymethyl cellulose that does not affect the human body.

### Crosslinking Agent

The cross-linking agent used in the present invention will be selected from agents capable of cross-linking the selected water-soluble polymer. In particular, in the present invention, a cross-linking agent that forms a hydrogen bond or an ionic bond with the fibrous polymer is preferable.

For example, when cross-linking with an acid, either an organic acid or an inorganic acid may be used. If it is an organic acid, at least one selected from formic acid, acetic acid, lactic acid, malic acid, succinic acid, maleic acid, oxalic acid, citric acid and the like is used. And, as for the inorganic acid, at least one selected from hydrochloric acid, sulfuric acid, nitric acid, phosphoric acid, polyphosphoric acid and the like is used.

Here, when a basic cross-linking agent is used, for example, ammonium carbonate, ammonium citrate and the like can be used.

On the other hand, when a metallic cross-linking agent is used, for example, calcium chloride, calcium carbonate, aluminum chloride, aluminum sulfate, aluminum lactate and the like, which are polyvalent metal salts, can be used.

It is considered that the valence of the cross-linking agent affects the strength when the gel is synthesized. For example, it is presumed that the larger the valence, the higher the strength of the synthesized gel.

### Freezing Speed

The solution in which the fibrous polymer is dissolved will be frozen, but there are no particular restrictions on the freezing rate and freezing temperature. By adjusting the freezing rate, it is possible to control the particle size of ice to some extent. More specifically, quick freezing reduces the particle size of ice, and slow freezing increases the particle size of ice. Therefore, if it is desired to adjust the surface area of the porous body obtained by removing moisture from the gel body, it can be achieved that just by adjusting the freezing rate.

The details will be explained in the items of principle and experimental examples, but it has been confirmed that the strength is improved by slow freezing rather than quick freezing.

### Thaw Rate

A cross-linking agent is added to the frozen body, and after reacting for a predetermined time, the frozen body is thawed to obtain a gel. Where, there is no limitation on the speed at which the frozen body is thawed.

### Principle

The reason why the strength of the gel can be improved by the method of synthesizing the gel according to the present invention has not been clarified. Therefore, it is just speculation, but it is considered that the strength of the gel may be improved by the following physical phenomena.

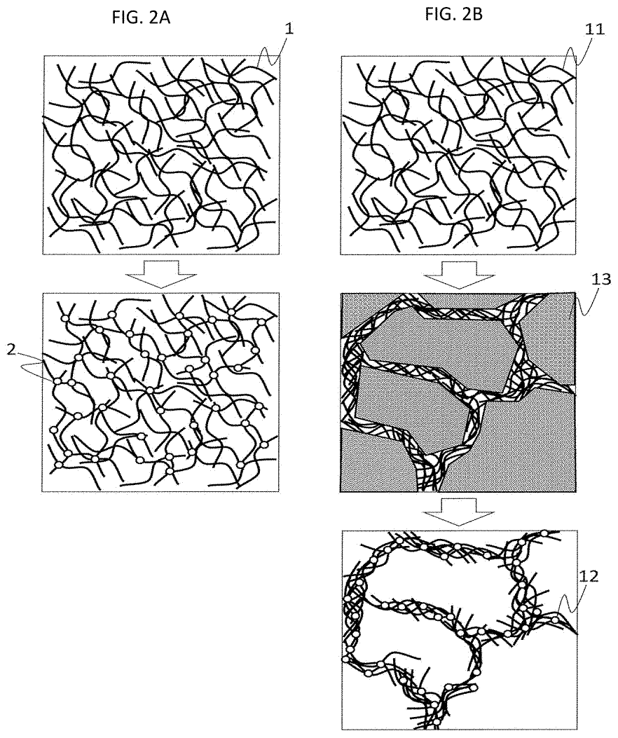

FIG. 2(a) schematically illustrating the concept of gel synthesis in the prior art, and FIG. 2(b) schematically illustrating the concept of gel synthesis according to the present invention.

The upper part of FIG. 2A shows a state in which carboxymethyl cellulose 1 is dispersed in water. This figure shows the state of step S2 in FIG. 1A. When the process proceeds to step S3 in FIG. 1(a), the state shown in the lower part of FIG. 2(a) is obtained, in which the circles indicate the cross-linked portion 2. In the gel synthesis in the prior art, since the reaction proceeds in the state of a solution, it is considered that the cross-linking reaction is promoted in a state where the density of carboxymethyl cellulose 1 is low. Therefore, it is considered that a gel having high strength cannot be obtained.

On the other hand, the upper view of FIG. 2(b) shows a state in which the fibrous polymer 11 is dispersed in water. This figure shows the state of step S12 of FIG. 1(b). It is presumed that when the process proceeds to step S13 of FIG. 1(b), the state shown in the middle of FIG. 2(b) is obtained. That is, it is considered that the water changes to ice 13 and pushes the fibrous polymer into a narrow space to increase the density of the fibrous polymer. Therefore, in step S14, which is the next step of FIG. 1(b), a cross-linking agent is added to the portion where the density of the water-soluble polymer is increased to form the cross-linked portion 12.

For the above reasons, it is presumed that a high-strength gel can be synthesized by using the gel synthesis method according to the present invention.

In addition, the reason why slow freezing improves strength compared to quick freezing is thought to be as follows. When quick freezing is performed, the fibrous polymer is not pushed away by the ice 13. As a result, a part of the fibrous polymer remains in the ice 13. That is, the fibrous polymer is not sufficiently pushed into the narrow space, and the density of the fibrous polymer cannot be increased, so that the strength is slightly weaker than that produced by slow freezing.

On the other hand, when slow freezing is performed, ice grows gradually, so there is enough time to push away the fibrous polymer. Therefore, it is considered that the density of the fibrous polymer is sufficiently increased and thus a high-strength gel can be synthesized.

### Others

Although not described in the explanation of FIG. 1(b) above, it is also possible to impart specific properties to the finished gel by adding various substances in step S12.

For example, by adding clay minerals and activated carbon powder when a fibrous polymer is dissolved in water, it is possible to significantly improve the adsorption performance of the porous body obtained by drying the gel. Clay minerals and activated carbon powder were given as examples as adsorbents, but any adsorbent that has adsorption performance and is dispersible in a solvent can be added.

When the above additives are added, it is possible to add properties that are also useful for adsorbing gases such as ammonia, carbon dioxide, and hydrogen sulfide.

Further, by adding iodine, silver ion, activated carbon, etc., it is possible to impart bactericidal properties, antiviral properties, etc. to the porous body obtained by drying the gel. Iodine has been mentioned as an example of a material that imparts bactericidal properties, but any material that has bactericidal properties and is dispersible in a solvent can be added.

Further, by adding a titanium acid compound such as titanium oxide, photocatalytic activity can be imparted to the gel or the porous body obtained by drying the gel. As an example of the material for imparting photocatalytic activity, a titanium acid compound has been mentioned as an example, but any material that has photocatalytic activity and is dispersible in a solvent can be added. The porous body obtained by drying the gel can be controlled from a filter shape to a sponge shape depending on the thickness thereof. Details will be described in later experimental examples.

Further, by adding a hydrophobic molecule such as cholesterol or fatty acid, the porous body obtained by drying the gel can be imparted with hydrophobicity or the like and used as an adsorbent for the hydrophobic molecule. Cholesterol and fatty acids have been mentioned as examples of materials that impart hydrophobicity, but any material that has hydrophobicity and forms the bond with the functional group of the polymer can also be added.

As the gel drying method, various drying methods such as freeze drying, ethanol substitution drying, and heat drying can be used.

In this embodiment, water and a fibrous polymer are used as an example to make the explanation easier to understand. But, it becomes possible to obtain a high-strength gel or a porous body as in the case of using water by using an organic solvent that can be solidified by cooling.

On the other hand, when water alone is used instead of an organic solvent, there are various merits as follows. The cost of procuring water is low, since the freezing temperature is 0° C., the cooling cost can be suppressed, it takes less time to make the gel, and more, it is easy to obtain larger gels and porous bodies. Further, since there is no organic solvent component remaining in the gel or the porous body, it is possible to provide the gel or the porous body that is friendly to the human body. Needless to say, water alone may contain some organic components as impurities.

Next, some experimental examples according to the present invention will be described.

### EXPERIMENTAL EXAMPLE 1

2 g of commercially available carboxycellulose nanofibers (2 weight percent of BiNFi-s (TFo-10002) made by Sugino Machine Limited) were placed in a container and frozen overnight at −20° C. to obtain a frozen product.

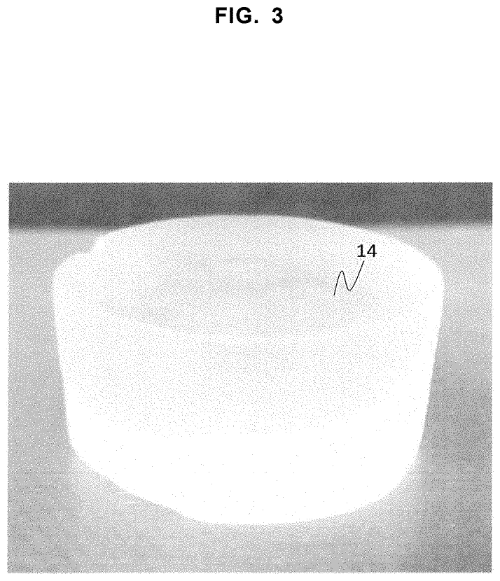

After adding 2 mL of 2 mol aqueous citric acid solution 1 (030-05525 made by Fujifilm Wako Pure Chemical Industries, Ltd.) to the obtained frozen body, the frozen body made melted by leaving it stand overnight at −4° C. By the above steps, the gel 14 shown in FIG. 3 was obtained.

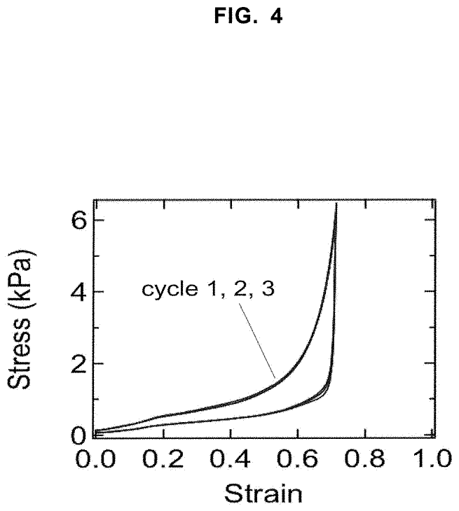

A part of the obtained gel was dried by a freeze dryer (FDU-1100 made by EYELA) and the weight change was measured. As a result, the water content was 94.7%. The porosity was 98.9%. Further, with the gel immersed in water, the stress-strain curve was measured by repeating the compression test three times using a texture analyzer (TA.XAPlus) made by Table Micro Systems. To measure the stress-strain curve, use a cylindrical probe (diameter 20 mm) to push up to 80% compression at a speed of 1 mm/sec, raise it at 1 mm/sec, and set the point where a load of 2 gf is detected as the zero position. The measurement was performed as one cycle. The result is shown in FIG. 4.

In the measurement of this stress strain curve, it was a result that the curve which was substantially the same as all three measurements was shown. This means that the gel obtained using the synthesis method according to the present invention does not change the structure by repeated compression. In other words, if it is explained in more detail, it means that it is a gel with excellent water supply and water retention that is difficult to discharge water by compression.

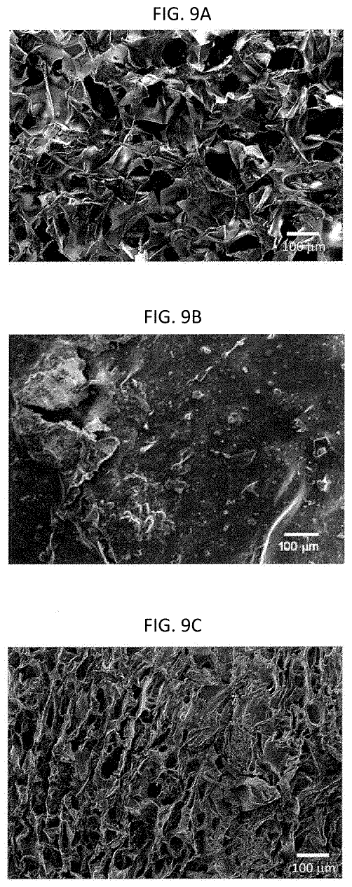

Furthermore, in order to observe the surface state of the obtained gel, measurements were performed using a scanning electron microscope (JSM-6010PLUS/LA) made by JEOL. The result is shown in FIG. 9A.

Looking at the surface state of the gel, it can be seen that a large hole is formed. This is considered to be a result of showing the gel formation as shown in the above-described principle.

### Comparative Example 1

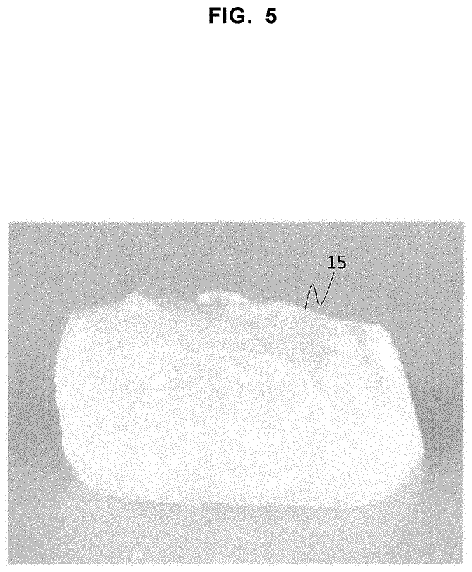

2 g of commercially available carboxycellulose nanofiber (made by Sugino Machine Co., Ltd., BiNFi-s (TFo-10002), 2% by weight) was placed in a container, and 2M citric acid (made by Fujifilm Wako Pure Pharmaceutical Co., Ltd., 030-05525) was added extremely quietly and placed overnight. At this time, the gel was not formed when citric acid was normally added or stirred to the cellulose nanofiber aqueous solution. When added extremely quietly, the gel 15 shown in FIG. 5.

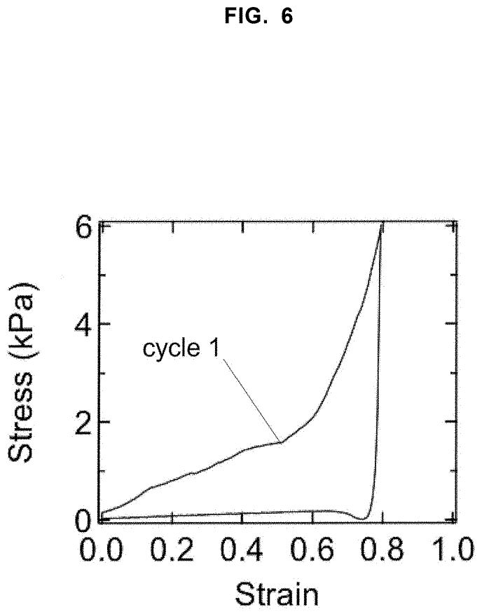

When a part of the gel was dried with a freeze dryer (FDU-1100 made by EYELA) to measure the weight change, the water content was 84.8%, and the porosity is 96.6%. In addition, with water flooded in this gel, a texture analyzer (TA. Compression tests were performed using XAPlus) and stress strain curves were measured. The measurement conditions were measured under the same conditions as in experiment example 1. The result is shown in FIG. 6.

In the measurement of this stress-strain curve resulted in the gel crushing in one measurement. This indicates that the gel obtained by the conventional synthetic method has not been able to form a strong crosslinked structure. To put it the other way around, it shows that the gel formed a strong crosslinked structure can be obtained by using the synthetic method according to the present invention. It was also found that when the synthetic method according to the present invention was used, substantially the same stress-strain curve could be measured at least twice.

Further, in order to observe the surface condition of the obtained gel, measurement was performed using a scanning electron microscope (JSM-6010PLUS/LA) made by JEOL Ltd. in the same manner as in experimental example 1. The result is shown in FIG. 9(b).

Looking at the surface condition of the gel obtained by this synthesis method, it can be seen that there are no large pores as in embodiment 1. This is considered to be a result indicating that gel formation is performed in a state where the fiber density is lower than that in experimental example 1.

### EXPERIMENTAL EXAMPLE 2

2 g of commercially available carboxycellulose nanofiber (Sugino Machine Limited, BiNFi-s (TFo-1002), 2 weight percent) was placed in a container and instantly frozen at −70° C. to obtain a frozen product.

To the obtained frozen product, 2 mL of a 2 M aqueous citric acid solution (made by Fujifilm Wako Pure Chemical Industries, Ltd., 030-05525) was added, then the frozen product was allowed to stand overnight at −4° C. to thaw the frozen product. A gel was obtained by the above steps.

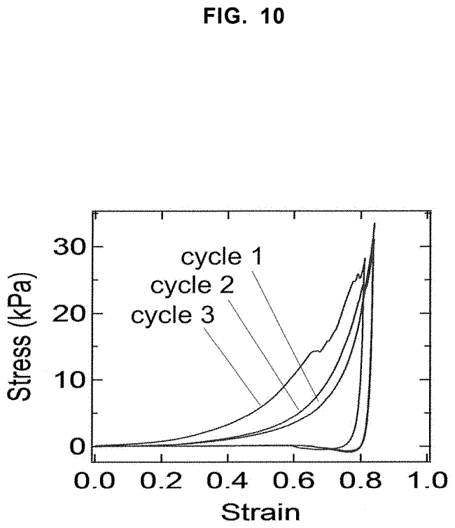

A part of the obtained gel was dried by a freeze dryer (FDU-1100 made by EYELA (Tokyo Rikakikai Co., Ltd.)) and the weight change was measured. As a result, the water content was 70.3%, and the porosity was 53.5%. Further, with the gel immersed in water, the stress-strain curve was measured by repeating the compression test three times using a texture analyzer (TA.XAPlus) made by Table Micro Systems. The measurement was performed under the same measurement conditions as in experimental example 1. The result is shown in FIG. 10.

In the measurement of this stress-strain curve, unlike experimental example 1, the curve was not shown to be substantially the same in all three measurements, but the gel did not crush. This indicates that the gel obtained by using the synthetic method according to this experimental example has higher strength than the gel obtained in comparative example 1 as compared with comparative example 1.

Furthermore, in order to observe the surface condition of the obtained gel, measurement was performed using a scanning electron microscope (JSM-6010PLUS/LA) made by JEOL Ltd. in the same manner as in other experimental examples. The result is shown in FIG. 9(c).

Looking at the surface condition of the gel, it can be seen that pores larger than those of comparative example 1 are formed, but the pores are not as large as in experimental example 1. This is as shown in the above principle, when quick freezing is performed, the fibrous polymers are bound in the ice and the density of the fibrous polymers cannot be increased. It is considered that the result was that a hole as large as experimental example 1 could not be secured.

### EXPERIMENTAL EXAMPLE 3

In this experimental example, the conditions are the same as in experimental example 1 except for the amount of the cross-linking agent added, and the amount of citric acid is 1M. The water content of the obtained gel was 94.8%, and the porosity was 98.6%.

As a result of measuring the stress-strain curve for the obtained gel, almost the same curve was shown in three compression tests.

### EXPERIMENTAL EXAMPLE 4

In this experimental example, the conditions are the same as in experimental example 1 except for the amount of the cross-linking agent added, and the amount of citric acid is 0.5 M. The water content of the obtained gel was 94.3%, and the porosity was 98.7%.

As a result of measuring the stress-strain curve for the obtained gel, there was a slight deviation in each curve in the three measurements, but the deviation was not as large as in experimental example 2. Furthermore, in this measurement, the gel was not crushed.

### Comparative Example 2

In this experimental example, the conditions are the same as in experimental example 1 except for the amount of the cross-linking agent added, and the amount of citric acid is 0.1 M. The water content of the obtained gel was 96.6%, and the porosity was 99.3%.

As a result of measuring the stress-strain curve for the obtained gel, the gel crushed in one measurement.

### Comparative Example 3

In this experimental example, the conditions are the same as in experimental example 1 except for the amount of the cross-linking agent added, and the amount of citric acid is 0.05 M. The water content of the obtained gel was 97.9%, and the porosity was 99.6%.

As a result of measuring the stress-strain curve for the obtained gel, the gel crushed in one measurement.

### Discussion for Each Experimental Example and Each Comparative Example

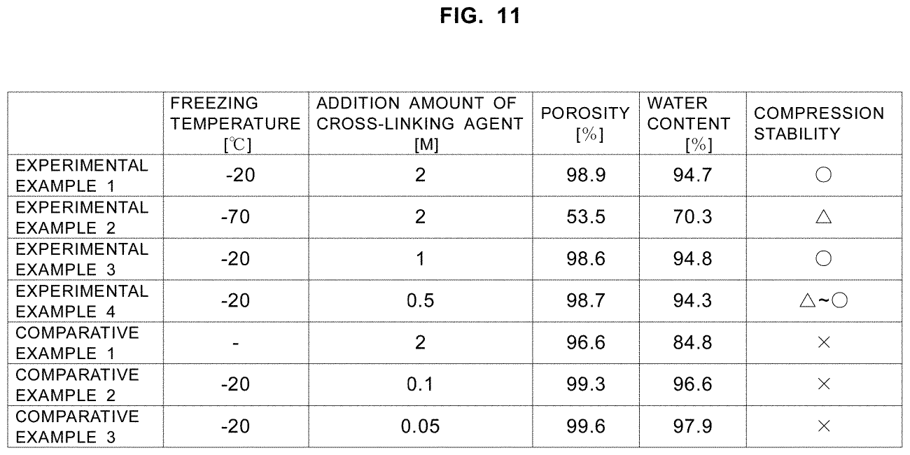

FIG. 11 shows a summary of the measurement results of experimental example 1 to experimental example 4 and comparative example 1 to comparative example 3. In the result of compressive stability by stress-strain measurement, the x mark indicates examples in which the gel was crushed in one measurement, the Δ mark indicates examples in which substantially the same curve is not shown in three measurements, but the gel was not led to crushing, and the ○ mark indicates examples showing substantially the same curve in three measurements are shown. In experimental example 4, since the curves are almost the same in the three measurements, the evaluation is from Δ to ◯. A feature common to the four experimental examples from experimental example 1 to experimental example 4 is that the gel is not destroyed when pressed to 80% compression.

### About the Amount of Cross-Linking Agent Added

Comparing the respective results of experimental example 1, experimental example 3, experimental example 4, comparative example 2, and comparative example 3, in which the freezing temperature was fixed and only the amount of the cross-linking agent added was changed. Regarding the compressive stability in this experimental example, it can be seen that generally sufficient strength is obtained when the amount of the cross-linking agent added is 0.5 M or more. On the other hand, when the amount of the cross-linking agent added was 0.5 M, a slight deviation occurred in the measurement of the stress-strain curve. Therefore, if the strength of the gel is to be improved more reliably, it is preferable to add a cross-linking agent of 1 M or more. Further, the larger the amount of the cross-linking agent, the higher the cross-linking density. Therefore, the upper limit thereof is not particularly limited, and the saturated dissolution amount of the cross-linking agent in the solvent is the upper limit. And, since the amount of the cross-linking agent added depends on the valence of the cross-linking agent used, it goes without saying that the required amount may vary depending on the cross-linking agent.

### Regarding the Presence or Absence of Cross-Linking in the Frozen State

As can be seen by comparing experimental example 1 and comparative example 1, it is clear that if the amount of the cross-linking agent added is the same, the strength is further improved by cross-linking in the frozen state. Therefore, as a requirement to increase the strength as compared with the conventional gel, it is important to carry out cross-linking in a frozen state.

### About the Size of Pores, Porosity and Water Content

As can be seen from the results of observing the surface state of the gel, when comparing the gel according to the present invention with the gel crosslinked without freezing, the gel according to the present invention has larger pores.

On the other hand, it can be seen that there is no particular commonality in the relationship between gel strength and water content/porosity. Conversely, it can be said that the porosity and water content can be adjusted while ensuring the strength of the gel by adjusting the freezing rate.

Therefore, by using the present invention, it is possible to adjust the water content and porosity according to the application while ensuring the strength having resilience, and it can be expected to be applied to various fields.

### EXPERIMENTAL EXAMPLE 5

2 g of commercially available carboxycellulose nanofiber (Sugino Machine Limited, BiNFi-s (TFo-1002), 2 weight percent) was placed in a container, and 40 mg of bentonite (Volkley, Volkre Bentonite), which is one of the clay minerals, was added to 2 g of the aqueous solution and stirred. An aqueous solution in which bentonite was diffused was placed in a container and frozen at −20° C. overnight to obtain a frozen product.

To the obtained frozen product, 2 g of 2M citric acid (made by Fujifilm Wako Pure Chemical Industries, Ltd., 030-05525) is added, then the frozen product is allowed to stand overnight at −4° C. to thaw the frozen product. By the above steps, a gel in which bentonite was dispersed was obtained.

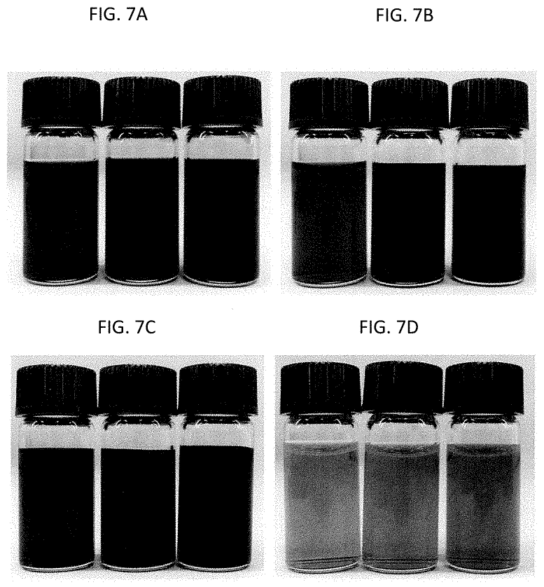

The obtained gel was freeze-dried to obtain a porous body. As shown in FIG. 7, an aqueous solution containing each of (a) Basic blue (made by Tokyo Chemical Industry Co., Ltd., B1301), (b) Methylene blue (made by Tokyo Chemical Industry Co., Ltd., A5015), (c) Malachite green (made by Tokyo Chemical Industry Co., Ltd., A5100), (d) Rhodamine B (made by Tokyo Chemical Industry Co., Ltd., R0040) dyes was prepared, and this porous body was added.

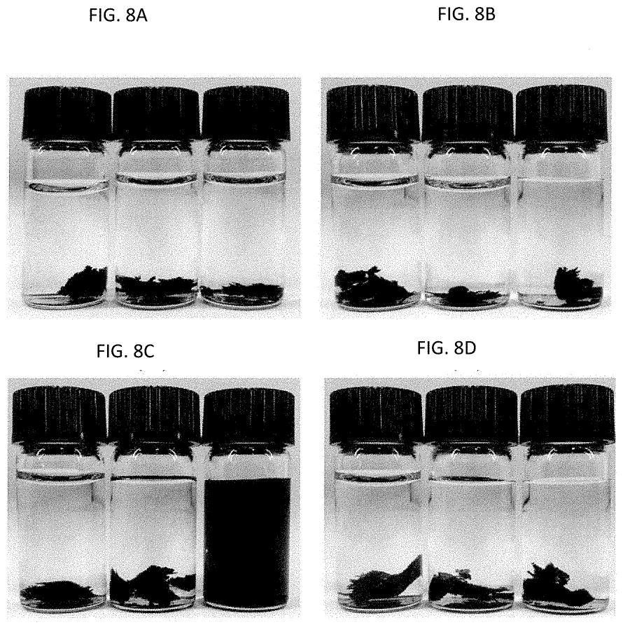

FIG. 8 shows the result of stirring after the addition of the porous body and allowing it to stand for 12 hours. (a) is a blue basic blue aqueous solution of FIG. 7(a), (b) is a blue methylene blue aqueous solution of FIG. 7(b), (c) is a blue-green malachite green aqueous solution of FIG. 7(c), (d) is a bright red Rhodamine B aqueous solution shown in FIG. 7(d), respectively.

As shown in FIG. 8, it was confirmed that each of the porous bodies adsorbed the dye.

As shown in FIG. 8, the dye adsorption capacity of the porous body was higher than that when carboxymethyl cellulose and bentonite were added together. This means that the porous body of the present invention can improve the dye adsorption power of the constituent components. The principle is not yet clear, but it is considered that the adsorption area was improved because the layered structure of bentonite was peeled off by freezing during gel synthesis.

In this experimental example, bentonite was added after adjusting the carboxymethyl cellulose aqueous solution, but it goes without saying that bentonite may be added at the same time as the adjustment of the carboxymethyl cellulose aqueous solution.

In addition, the freeze-drying method was used in the step of obtaining a porous body from which water was removed from the gel, but any drying method can be applied as long as the drying method does not change the composition of the polymer. It is possible. In particular, it is also possible to use an ethanol substitution drying method, a heat drying method or natural drying instead of freeze-drying as described above. When a drying method other than the freeze-drying method is used, the productivity of the porous body can be improved, which is very effective in reducing the cost.

### EXPERIMENTAL EXAMPLE 6

In this experimental example, a method of drying the gel to obtain a film-like porous body will be described.

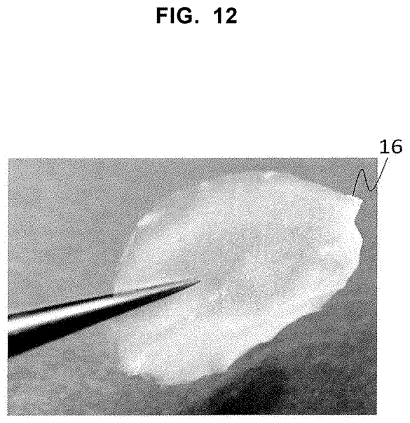

First, a gel having a thickness of 0.5 mm is obtained by the same method as in experimental example 1. The gel was placed on a sheet of polydimethylsiloxane and air dried. The film-like porous body 16 obtained as a result is shown in FIG. 12.

The gel with a thickness of 0.5 mm becomes a film-like porous body with a thickness of 0.1 mm after drying. Therefore, by adjusting the thickness of the gel to be prepared, the porous body obtained after drying can be made into a film or a sponge having a certain thickness.

In addition, although it was dried on polydimethylsiloxane in this experimental example, it is of course possible to dry it on a glass plate. However, it is very interesting that the strength of the porous body 16 as a film is stronger when it is dried on polymethylsiloxane. It is considered that this is because the interaction between the gel body and the polydimethylsiloxane sheet is small and no extra stress is applied to the gel body during drying, so that the strength of the film-like porous body is increased. That is, when determining the strength of a film-like porous body, it is preferable to place it on a sheet of polydimethylsiloxane and dry it.

The first embodiment is briefly summarized. In order to solve the above problems, the method of preparing a porous body according to the present invention is characterized by having a first step of dissolving fibrous polymers each having a reactive functional group in a solution, a second step of freezing the solution in which the fibrous polymers are dissolved, and a third step of cross-linking fibrous polymers to each other by adding a predetermined amount of cross-linking agent to the frozen solution.

By using the above method, fibrous polymers can be crosslinked with each other in a state where the density of the polymer is increased at the time of freezing, so that a gel having higher strength than that of the prior art can be obtained.

Further, the method of synthesizing a gel or a porous body according to the present embodiment is characterized in that carboxymethyl cellulose is used as a polymer and citric acid is used as a cross-linking agent.

By using the above method, since a natural polymer and citric acid that is harmless to the human body are used, it is possible to provide a gel or a porous body that can be safely used even for medical purposes.

Further, the method of synthesizing a gel or a porous body according to the present embodiment is characterized in that a clay mineral or activated carbon powder is added to the solution at the same time as the first step or after the first step.

By using the above method, the adsorption performance originally possessed by the gel or the porous body can be further improved, so that it become possible also to use for purification of liquids and the like.

Further, in the method of synthesizing a gel or a porous body according to the present embodiment, either iodine, titanium oxide or silver ion is added to the solution at the same time as the first step or after the first step.

By using the above method, bactericidal properties can be imparted to gels and porous materials, so that it can be used for products that require sterilization or disinfection.

Further, the porous body described in the present embodiment is characterized in that it is prepared by arranging the gel on polydimethylsiloxane and drying.

By using the above method, the strength of the porous body can be improved.

Although the embodiment of the present invention has been described with reference to the drawings, the specific configuration is not limited to those embodiments, and even if there is a design change or the like within a range that does not deviate from the spirit of the present invention, they are included in the range of present invention.

1. A method of producing a gel comprising:
a first step of dissolving fibrous polymers each having a reactive functional group in a solution,
a second step of freezing the solution in which the fibrous polymers are dissolved, and
a third step of cross-linking fibrous polymers to each other by adding a predetermined amount of cross-linking agent to the frozen solution.

2. The method of producing a gel according to claim 1, wherein
said fibrous polymers each having a reactive functional group are carboxymethyl cellulose, and said cross-linking agent is citric acid.

3. The method of producing a gel according to claim 1, wherein
at least one selected from a group of clay minerals, activated carbon powder, titanium oxide, iodine, and silver ion is added to said solution at the same time as said first step or after said first step.

4. A method of producing a porous body wherein:
a gel drying step is provided after said third step in a method of producing a gel according to claim 1.

5. A porous body wherein:
said porous body is obtained by cross-linking in a frozen state the solution in which fibrous polymers each having a reactive functional group are dissolved, thawing the frozen solution after cross-linking, then drying.

6. The porous body according to claim 5, wherein
said fibrous polymers each having a reactive functional group are carboxymethyl cellulose.

7. The porous body according to claim 5, wherein
at least one selected from a group of clay minerals, activated carbon powder, titanium oxide, iodine, and silver ion is included in said porous body.

8. A gel having porous structure, wherein
when compressed at an 80% compressibility, said gel has substantially the same stress-strain curve for at least twice compressions.

9. The gel according to claim 8, wherein
said gel contains carboxymethyl cellulose as a main component.

10. The gel according to claim 8, wherein
said gel contains at least one selected from a group of clay minerals, activated carbon powder, titanium oxide, iodine, and silver ion.
